(19) United States
(12) Patent Application Publication
(10) Pub. No.: US 2004/0100109 A1
(43) Pub. Date: May 27, 2004

(54) Extendable, non-rotating reacher

(76) Inventor: Richard Del Johnson, Redmond, OR (US)

Correspondence Address: GLENN C. BROWN, PC, 777 NW WALL STREET, SUITE 308, BEND, OR, 97701, US

(21) Appl. No.: 10/304,588

(22) Filed: Nov. 25, 2002

(51) Int. Cl. B25J 1/00

(52) U.S. Cl. 294/26; 294/19.1

(57) ABSTRACT

An extendable reacher having a plurality of extendable sections, including a center section. The center section includes a distal portion that inserts into an opening in the rear wall of the handle to retain the reacher in its retracted position. The extendable sections include outer and inner surfaces that engage to prevent relative rotation of the sections and the tip.

This application is related to remote reachers, and in particular, to extendable reachers that can be used to avoid bending or dismounting a vehicle or an animal for equestrian users.

### BACKGROUND OF THE INVENTION

Extendable reachers are well-known, and have been used in many forms. An extendable reacher has the advantage of being collapsible to a compact dimension for easy transport and storage. Equestrian users find a reacher very convenient for retrieving articles of clothing or equipment that have been dropped, or for retrieving the reins of a nearby horse or other animal. Equestrian users are limited however in the storage space available while riding, and in the size of equipment that can be conveniently carried while mounted. Recall that even early rifle designs were shortened for more convenient carrying and use on horseback.

There are additional considerations that render known reacher designs unsuitable for use by riders. First, a desirable form of the tip for a reacher is a curved hook for snagging the widest variety of items. One disadvantage of a curved hook, however, is that that if it rotates the snagged item will likely be dropped. It is also very difficult to snag a particular item of the hook freely rotates. A second difficulty with using a reacher while on horseback is that the reacher must be operable with one hand if the rider is to have one hand free for the reins. For these and other reasons, known reacher designs are not well-suited for use on horseback.

### SUMMARY OF THE INVENTION

This invention overcomes the shortcomings of the prior art by providing an extendable reacher that is compact for convenient storage and carrying while on horseback. The reacher according to this invention provides other advantages over the prior art as well in that it can be extended and retracted using only one hand, and which when extended will not permit the tip to rotate relative to the body of the reacher. Finally, the reacher will not extend unintentionally. These and other features of the invention will now be described in greater detail with reference to the drawings.

### BRIEF DESCRIPTION OF THE DRAWINGS

FIG. 1 is a perspective view of a reacher according to a preferred embodiment of the invention, and which is shown in its extended configuration.

FIG. 2 is a side elevational view of the embodiment of the invention shown in FIG. 1.

FIG. 3 is a side cross-sectional view of a typical single section of the preferred embodiment of the invention.

FIG. 4 is an end cross-sectional view of a preferred embodiment of the invention showing the cross-sectional shape of the telescoping sections.

FIG. 5 is a side cross-sectional view of the embodiment of the invention shown in FIG. 1, and in its collapsed configuration.

FIG. 6 is a top cross-sectional view of the embodiment of the invention shown in FIG. 5.

FIG. 7 is a side cross-sectional view of the embodiment shown in FIGS. 5 and 6, and showing the reacher partially extended.

FIG. 8 is a plan view of an alternative embodiment in which the reacher is maintained in its closed position by means of a split end portion of a central member.

### DETAILED DESCRIPTION OF THE INVENTION

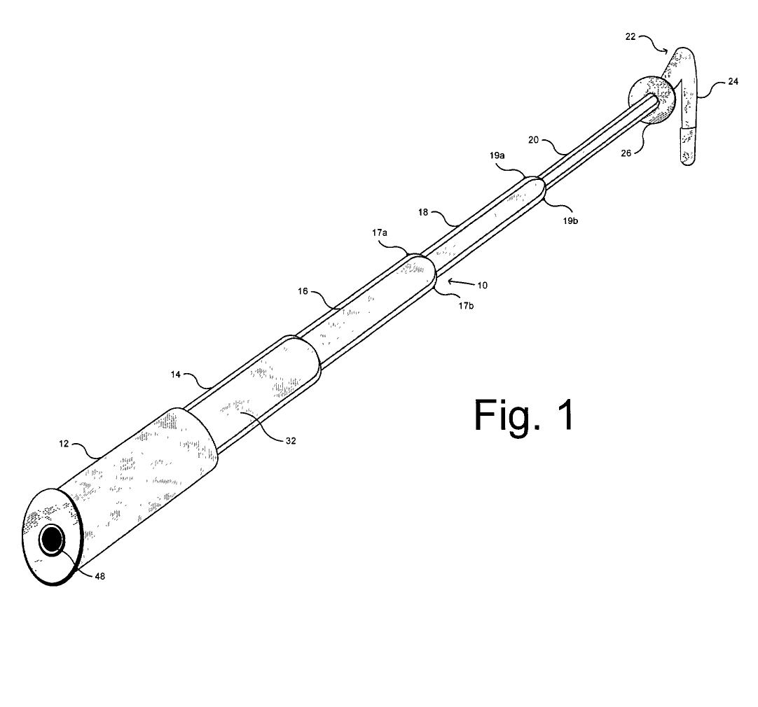

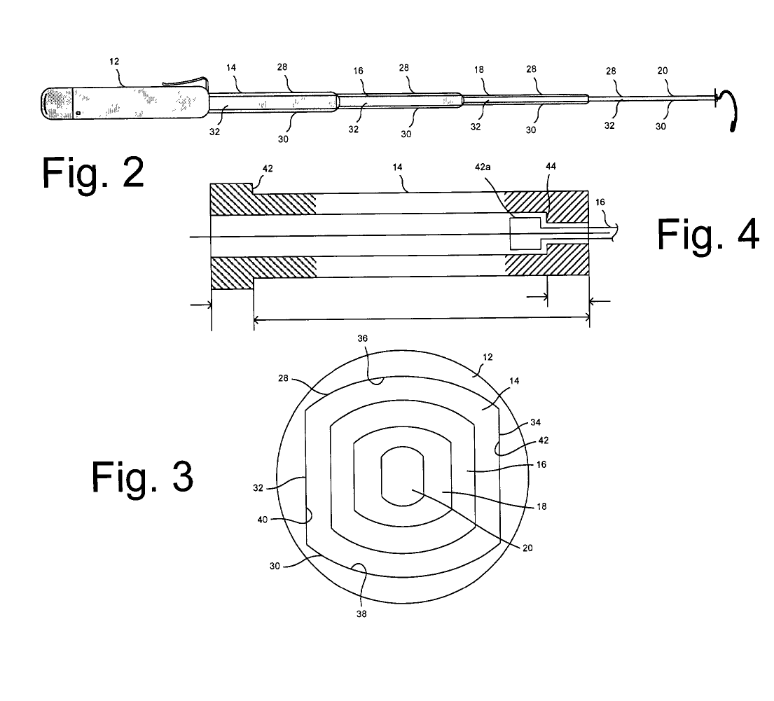

Turning now to FIGS. 1-7, a preferred embodiment of the invention is shown generally at 10. Reacher 10 comprises handle 12, four telescoping sections 14, 16, 18, and 20. While the illustrated embodiment includes four extendable sections, the invention is not litmited to any specific number of sections. A tip 22 is mounted on the distal end of section 20, and in this embodiment includes a hook 24. A flange 26 is mounted at the base of hook 24 to provide a stop that can prevent slippage of a snagged item off of the hook.

Each of the telescoping sections 14-20 includes rounded outer top and bottom surfaces 28 and 30 respectively, and flat outer side surfaces 32 and 34. Handle 12 and each of telescoping sections 14, 16 and 18 are hollow, and each includes rounded inner top and bottom surfaces 36 and 38 and flat inner side walls 40 and 42. Telescoping section 20 can be either solid or hollow, but if hollow the inner profile is not critical since it does not receive a telescoping section within. The combination of rounded and flat surfaces described provides a significant advantage over known reachers in that this combination of surfaces prevents relative rotation of the telescoping sections, providing the disadvantages of prior art reachers as described above. While in the preferred embodiment the side walls are flat, in other embodiments a single side wall could be flat, or one or both side walls could be rounded but with a different radius than the top and bottom walls, thereby providing a similar advantage, although the illustrated design is believed to be preferable.

Turning now to FIG. 4, each telescoping section will now be described in greater detail. The telescoping motion of sections 14, 16, and 18 have been described above. FIG. 4 shows a partial side cross-sectional view of sections 14 and 16, and shows outer flange 42 and inner shoulder 44 that is formed on each of sections 14, and outer flange 42a that is formed on section 16. As section 16 is extended relative to section 14, outer flange 42a of section 16 engages inner shoulder 44 of section 14 to limit the relative travel of section 16. In the embodiment illustrated, flange 42 and inner shoulder 44 are continuous around the perimeter of each section, but in other embodiments could extend only partially around the perimeter.

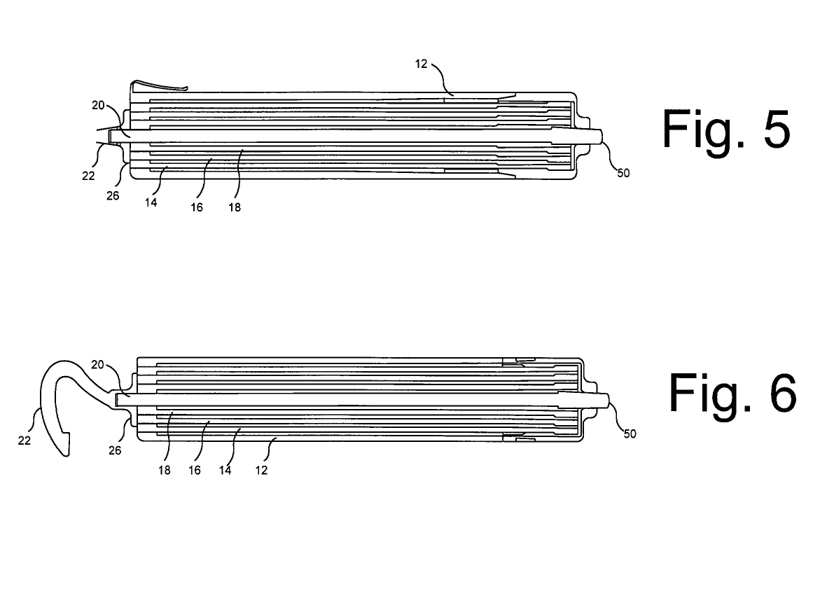

Turning to FIGS. 5 and 6, another feature of the invention will be described. As mentioned above, if a reacher is to be used on horseback, it must be compact as well as operable with one hand. This invention combines those aspects in the following novel way. The rear surface of handle 12 includes an opening 48 (FIG. 1). Section 20 can be seen in FIGS. 5 and 6 to be of a length that when sections 14, 16, and 18 are telescoped inwardly into handle 12, the end portion 50 of section 20 extends through opening 48. End portion 50 is sized such that there is an interference fit between end portion 50 and opening 48. As a result, when the assembly is collapsed as shown in FIGS. 5 and 6, end portion 50 is engaged in opening 48 and prevents extension of sections 14, 16, 18, and 20 when the reacher 10 is carried and stored. The interference fit of about 0.005 inches is selected so that when a user wishes to extend the reacher, the user pushes on the protruding tip and forces it inwardly to release it from opening 48. The specific dimensions of end portion 50 and opening 48 can be readily determined by one skilled in the art to provide a desired level of force required to open the reacher.

Referring to FIG. 8, another embodiment is shown in which end portion 50 is split longitudinally. Each longitudinal section 52 and 54 is biased outwardly, and includes tabs 56 and 58 that engage opening 48 to retain end portion 50 therein. Portions 52 and 54 are squeezed together by the user to release end portion 50 from the opening 48, permitting the reacher to extend as described below.

This feature of the invention is of particular importance in that it provides a measure of safety in preventing the reacher from extending unintentionally during the normal jostling that takes place during riding. The reacher will also not extend if the horse or rider should fall, providing an even more important measure of safety in the event of such an accident.

Once end portion 50 is released from opening 48, the reacher is extended by merely pointing it downward. The materials of construction and clearances between the telescoping sections are such that the telescoping sections 14-20 extend easily under the force of gravity, allowing full extension without the need to use two hands. At the same time the profiles of the outer and inner surfaces prevent rotation of the tip relative to the handle. The reacher is collapsed by pointing it upward causing the telescoping sections to retract under the force of gravity. End portion is reinserted into opening 48 by a light push of tip 22 against a surface, locking the reacher into its retracted position.

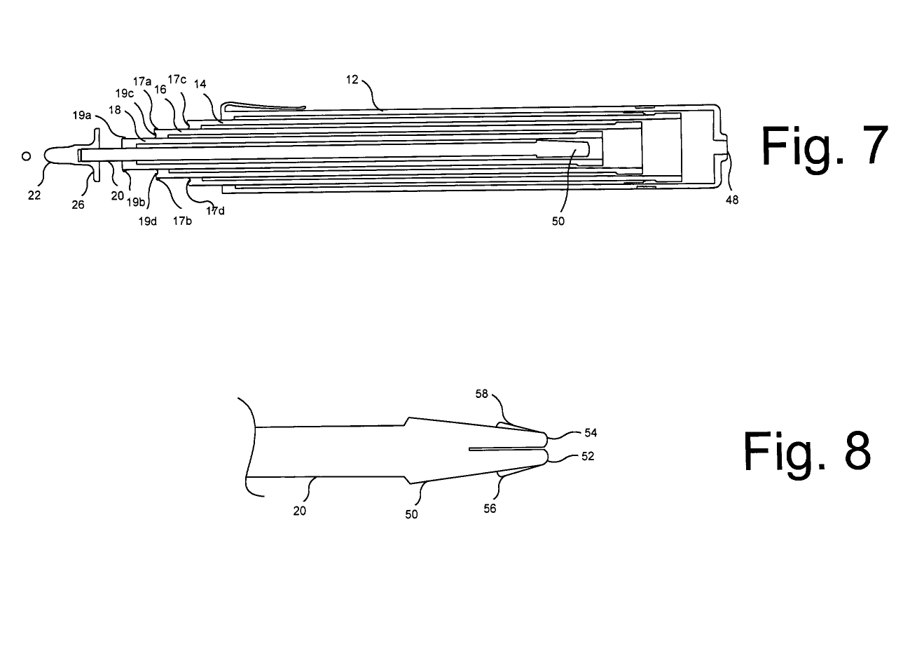

Referring again to FIG. 5, when the reacher is in its collapsed configuration a flange 26 overlaps the distal portions of extendable sections 14, 16 and 18 to retain them in position within handle 12. Referring to FIG. 7, when end portion 50 is released from opening 48, flange 26 is moved away from the distal portions of extendable sections 14, 16 and 18, permitting them to extend from handle 12. Referring to FIG. 7, in the preferred embodiment sections 16 and 18 include small beads or nubs 17a, 17b and 19a, 19b respectively, that prevent sections 16 and 18 from falling into handle 12. When the reacher is collapsed, nubs 17a and 17b are received in recesses 17c and 17d respectively formed in section 14. Nubs 19a and 19b are received in recesses 19c and 19d respectively.

The material from which the handle and the sections are formed is selected to have a coefficient of friction that provides a smooth, measured sliding relationship between the adjacent sections and handle. The preferred material of construction is zytel®, but other materials that embody the requisite strength, formability and lubricity could also be used to provide the desired combination of properties.

While this invention has been described by reference to the preferred embodiments described above, those of skill in the arts will recognize that numerous modifications in detail and arrangement are possible without departing from the scope of the following claims, the full scope of which is claimed.

What is claimed is:

1. An extendable device comprising:
a hollow handle having a non-circular inner surface, a rear wall, an opening in the rear wall, and a first shoulder on the inner surface;
a first hollow, extendable section disposed at least partially within the hollow handle including an outer surface slidingly engageable in a non-rotatable relationship with the inner surface of the handle, a first flange on the outer surface and engageable with the first shoulder, and a non-circular inner surface with a second shoulder; and,
a shaft slidingly disposed at least partially within the extendable section, the shaft having an outer surface slidingly engageable in a non-rotatable relationship with the inner surface of the first extendable portion, a first end portion engageable with the rear wall opening, a distal end, a second flange engageable with the second shoulder, and a retainer engageable with the first extendable section.

2. An extendable device comprising:
a hollow handle having a non-circular inner surface, a rear wall, an opening in the rear wall, and a first shoulder on the inner surface;
a first hollow, extendable section disposed at least partially within the hollow handle including an outer surface slidingly engageable in a non-rotatable relationship with the inner surface of the handle, a first flange on the outer surface and engageable with the first shoulder, and a non-circular inner surface with a second shoulder;
a second hollow, extendable section disposed at least partially within the first extendable section and including an outer surface slidingly engageable in a non-rotatable relationship with the inner surface of the first extendable section, a second flange on the outer surface and engageable with the second shoulder, and a non-circular inner surface with a third shoulder; and,
a shaft slidingly disposed at least partially within the second extendable section, the shaft having an outer surface slidingly engageable in a non-rotatable relationship with the inner surface of the second extendable portion, a first end portion engageable with the rear wall opening, a distal end, a third flange engageable with the third shoulder, and a retainer engageable with the extendable section.

3. An extendable device comprising:
a hollow handle having a non-circular inner surface, a rear wall, an opening in the rear wall, and a first shoulder on the inner surface;
a first hollow, extendable section disposed at least partially within the hollow handle including an outer surface slidingly engageable in a non-rotatable relationship with the inner surface of the handle, a first flange on the outer surface and engageable with the first shoulder, and a non-circular inner surface;
a second hollow, extendable section disposed at least partially within the first extendable member in a non-rotatable relationship with the handle, and having a non-circular inner surface with a second shoulder; and,
a shaft slidingly disposed at least partially within the second extendable section, the shaft having an outer surface slidingly engageable in a non-rotatable relationship with the inner surface of the second extendable portion, a first end portion engageable with the rear wall opening, a distal end, a second flange engageable with the second shoulder, and a retainer engageable with at least the second extendable section.

4. An extendable device according to claim 1 further comprising:
a hook on the distal end of the shaft.

5. An extendable device according to claim 2 further comprising:
a hook on the distal end of the shaft.

6. An extendable device according to claim 3 further comprising:
a hook on the distal end of the shaft.

7. An extendable device according to claim 1 wherein the first end of the shaft is sized for an interference fit with the opening in the end wall of the hollow handle.

8. An extendable device according to claim 2 wherein the first end of the shaft is sized for an interference fit with the opening in the end wall of the hollow handle.

9. An extendable device according to claim 3 wherein the first end of the shaft is sized for an interference fit with the opening in the end wall of the hollow handle.
